(19) United States
(12) Patent Application Publication
(10) Pub. No.: US 2017/0132733 A1
(43) Pub. Date: May 11, 2017

(54) SYSTEM FOR OPTIMIZATION OF GROUP INTERACTION

(71) Applicant: David Bain, Arlington, VA (US)

(72) Inventor: David Bain, Arlington, VA (US)

(21) Appl. No.: 15/245,352

(22) Filed: Aug. 24, 2016

Related U.S. Application Data
(63) Continuation of application No. 14/214,925, filed on Mar. 15, 2014, now abandoned.
(60) Provisional application No. 61/852,033, filed on Mar. 15, 2013.

(51) Int. Cl. G06Q 50/20; G06N 99/00; G06Q 10/10

(52) U.S. Cl. CPC G06Q 50/205; G06Q 10/10; G06N 99/005

(57) ABSTRACT

At least one aspect of this invention relates to a system, apparatus, and method for optimizing the interaction of large groups of people, such as, but not limited to large numbers of students enrolled in massive open online courses (MOOCs) or large audiences.

### CROSS REFERENCE TO RELATED APPLICATIONS

This application claims the benefit of U.S. Provisional Application 61/852,033, filed Mar. 15, 2013, entitled SYSTEM FOR OPTIMIZATION OF GROUP INTERACTION, which is incorporated herein by reference.

### BACKGROUND OF THE INVENTION

1. Field of the Invention

The present application relates to the fields of online learning, management systems for Massive Open Online Courses (MOOCs), videography, and systems for management of the interaction of very large groups generally.

2. Description of the Prior Art

Prior art include the Hillier “System for Capturing Student Performance” (U.S. Ser. No. 13/688,049) and Chitnis “Video Capture from Multiple Sources” (U.S. Ser. No. 13/176,327) which teach methods of capturing video and methods of capturing student performance.

None of the above inventions and patents, taken either singly or in combination, is seen to describe the instant invention as claimed.

### SUMMARY OF THE INVENTION

Accordingly, it is a principal object of a preferred embodiment of the invention to perform the subdivision of very large groups in to smaller subgroups enabling optimal small subgroup interaction.

It is another object of the invention to manage the asynchronous interaction of groups, following and enforcing a unique and useful sequence of steps.

It is a further object of the invention to provide a system through which subgroup participants may view and assess the recordings of their own subgroup as well as the recordings from the larger group determined to be exceptional.

It is a further object of the invention to store for viewing, assessment, and future retrieval the digital artifacts (e.g. video recordings) and associated metadata captured in this unique fashion.

It is an object of the invention to provide improved elements and arrangements thereof in an apparatus for the purposes described which is inexpensive, dependable and fully effective in accomplishing its intended purposes.

These and other objects of the present invention will be readily apparent upon review of the following detailed description of the invention and the accompanying drawings. These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

### BRIEF DESCRIPTION OF THE DRAWINGS

FIG. 1 is the flow diagram for the subdivision of large groups into subgroups based on a combination administrator preferences, subgroup member preferences, and computer implemented algorithms, multi-parameter optimization, big data analysis, deep learning, or other machine learning or artificial intelligence methods of determining optimal subgroup size and composition. Determined variables are stored in the schema of a database or data storage solutions as readily evident to one skilled in such art.

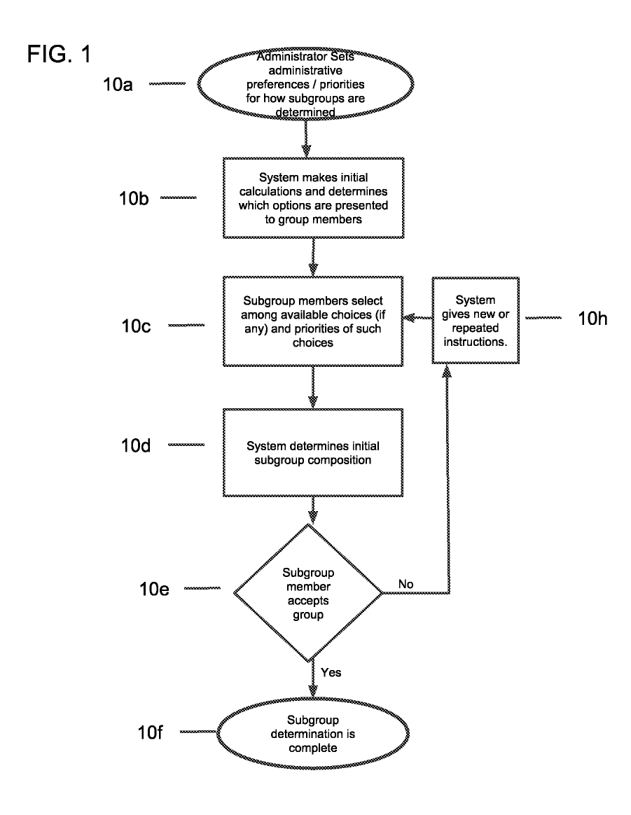

FIG. 2 is the flow diagram for the Subgroup Structured Interaction and Management Module, which enforces the steps of asynchronous (non-real time or not necessarily real time) interaction. Similar reference characters denote corresponding features consistently throughout the attached drawings.

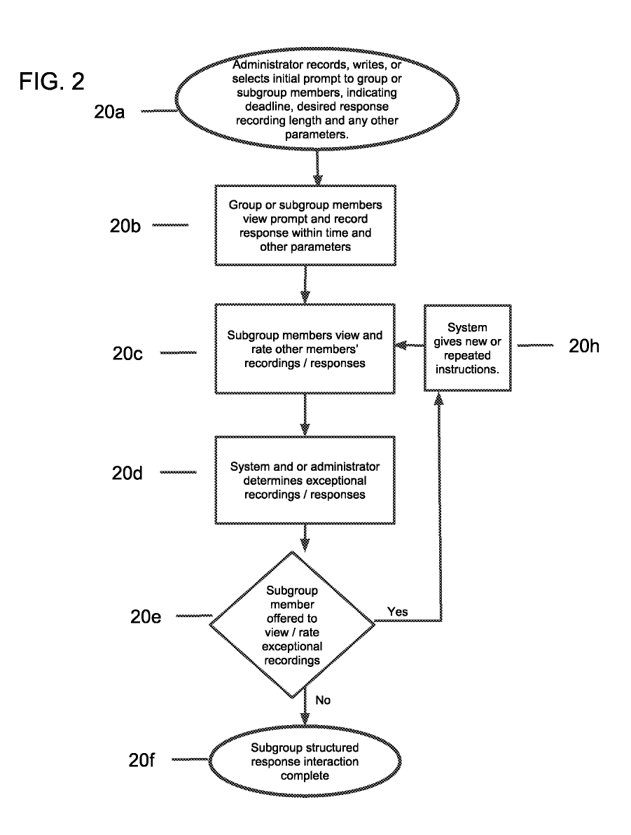

### DETAILED DESCRIPTION OF THE PREFERRED EMBODIMENT(S)

When large groups people interact, limitations including inherent limitations of time and space result in an experience for the group members and organizers and an outcome of the activity that is usually different and worse than when smaller groups are able to interact. In education, for instance, smaller classrooms usually provide students with a better learning experience than when they are in large groups for myriad reasons including the fact that as student-teacher ratio grows, the chance of interaction with instructors declines. As absolute class size grows, so does the difficulty of efficient interaction with the peer group. It is well established by primatologists that for species including humans there is a maximum effective number of individuals in a group with whom one may have meaningful, efficient interaction, a so called “Dunbar's number”. Another deficiency of large group interaction, such as in online courses, is the lack of opportunity for students to synthesize and vocalize the knowledge they have gained from a course, and a lack of evidentiary artifacts, digital or otherwise that would prove that the participant was indeed the person taking the course (and not, for instance a surrogate of some kind). The present invention solves these and other problems of group interaction by providing 1) a system to fairly and optimally divide large groups into smaller groups; 2) a system to allows organizers and members to record their interactions, such as with a video-enabled device, and for all parties privy to group interactions to view and respond to such recordings; 3) a system to enable the rating or judging of such content in such a way that the best (or preferred content according to specific criteria) from the entire group is made available to the entire group or others; 4) a system or method to optimize such group interaction components for specific use cases including, but not limited to, online learning, crowdfunding or fundraising from groups, contests, news or social media commentary, or audience participation to television, sports, political, musical, theater, charity or other events; and 5) a system or method of storing and archiving the digital artifacts of such interactions, such as videos, audio recordings, and all associated metadata, for purposes that may include, but not be limited to, the granting of academic credit or certifications for courses and training, proving of qualifications for specific tasks, jobs, careers, or other opportunities, or the creation of derivative works based on such content.

In the present invention, in the instance that the group for which interaction is being optimized is an unwieldy large group, then a central aspect of the system is a system, apparatus, and method consisting of algorithms and adjustable computer programming instructions to divide the group into smaller groups of size and composition so as to meet the optimal needs of the group or according to the preferences of the group organizers (administrators) or the group's members.

A second element is the system, apparatus, and method providing the facility for the group organizers and members to capture their interactions as recorded and stored or real-time media, in audio, video, or by any other means that may be readily stored and shared electronically.

A third element is the system, apparatus, and method enabling the rating or judging of content and selection of content according to specific attributes so that content may be used for specific purposed. For instance, in an online course with 500,000 participants, the present invention may automatically divide course participants into groups of 10 personas and instruct them to record a video response to a question about a course topic. Once the content is captured, participants may view and rate all the content produced by the members of their own small group. The content that is judged best among the group is advanced to the next stage of judging in which the best content from 10 groups is viewed by the members of ten groups, for instance. After several iterations of identifying the best responses, the best responses from the entire 500,000 students will have been identified and each participant will have seen all the responses from their small groups along with many of the best responses from other groups. This important element allows for the capture of hidden value of massive courses and other large groups: in any massive class, there will often be someone whose knowledge or insight on a given sub-topic is on par or greater than that of the instructor(s).

A fourth element of the present invention is a system, apparatus, and method for automatically adapting and optimizing the system for use and integration for different categories of groups such as the aforementioned large online class example or patients in group treatment for illness or addiction, or team member interaction in a large enterprise or government agency (which may be engaging in complex tasks such as disaster management, epidemic management, or terrorism prevention), contests and competitions, large audiences of any event, fans of a actor, musician, film, or production of any kind, and many others. In each case the system is equipped with templates and application programming interfaces (APIs) to facilitate rapid and low cost integration into the respective systems, databases, presentation layers and other layers for each use case. In the case of responses to media or other use cases given to interactive discussion, the database schema for the digital artifacts include fields that relate interactions with each other so that responses and rebuttals may be appropriately threaded as known to those skilled in the art of online discussion forums.

A fifth element is the system, apparatus and method to store the digital artifacts (e.g. recordings) and any associated metadata in such a way as to provide immediate iii and long-term utility. In the instance of online course records, for instance, the system may associate each recording to the course, topic, sub-topic which may as granularly as possible pinpoint the content. Accordingly, a future employer or human resources recruiter for a specific task or job may not only view the diploma of the candidate, but also view the proof and quality of thought and presentation regarding extremely specific topics. Under such as system, candidates may be valued more highly based on high ratings and proven knowledge in the extremely granular areas that relate most directly to the job requirements rather than an overall grade point average or even a specific course grade.

The present invention includes the software, system, and method for dividing groups into manageable units. Such division into smaller units may be based on the preferences of an organizer or administrator, or on the group members (through individual preferences or voting) or some combination of the above. For instance, small groups may be automatically diversified insuring a mix of age, skill level, gender, personality type, geographic location, etc. In other instances, it may make sense for students to be grouped with others of a similar skill level, geographic proximity, language group, etc. It is conceivable that groups may eventually include both human and artificial intelligence/robotic participants which may be specially programmed to facilitate the progress of the group on the level of a peer facilitator or introducer of connected or random elements to the discussion. Through the collection of metrics on group performance and size and composition, the system is able through methods known to those skilled in the art of multi-parameter optimization (ops research mathematics) automatically identify optimal group sizes and compositions for specific goals and topics. E.g., same gender groups of 10 or less may be best for Calculus, while a group reading of Romeo and Juliet may be efficient in diverse groups of up to 50.

The component that captures video or other recording may comprise a capture medium via a web, smartphone application, or other interface along with associated storage and transmission elements known to those skilled in the art of multi-media and online recording. Content may be stored and recorded in a preferred embodiment, but live or realtime performance of content by group members is certainly an aspect that adds additional value. For instance, in an online course, students may have recorded and stored their responses to the professor's prompts, but for the final presentation, they are required to log in at a specific time and record in realtime.

The aspect of the invention that relates to rating is as described previously. In addition, the system supports rating raters so that the quality of one's judging of one's peers or communicants may also be tracked and taken into consideration in calculating the subjectively judged attributes of captured content.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims. It is therefore to be understood that the present invention is not limited to the sole embodiment described above, but encompasses any and all embodiments within the scope of the following claims.

I claim:

1. A system, apparatus, and method for optimally subdividing massive groups into smaller groups comprised of administrative and group member preferences, implemented with multi-parameter optimization algorithms as may be evident to someone skilled in the field of operations research.

2. The system according to claim 1, which additionally employs artificial intelligence or deep learning to determine the optimal size and or composition of subgroups.

3. A system, apparatus, and method for enforcing the asynchronous recordings of members of a group or subgroup to prompts such that members of a group or subgroup may view and rate recordings of other members of their own group or subgroup and also view and rate the recordings of the exceptionally rated or specially identified recordings of members of other groups or subgroups.
